(19) United States
(12) Patent Application Publication
(10) Pub. No.: US 2003/0151231 A1
(43) Pub. Date: Aug. 14, 2003

(54) Foldable pallet-cart

(76) Inventor: Michael J. Calleja, Brisbane, CA (US)

Correspondence Address: Robert Charles Hill, 235 Montgomery Street #821, San Francisco, CA, 94104, US

(21) Appl. No.: 10/357,555

(22) Filed: Feb. 4, 2003

Related U.S. Application Data
(63) Continuation of application No. 09/717,760, filed on Nov. 21, 2000, now abandoned.

(51) Int. Cl. B62B 5/00

(52) U.S. Cl. 280/638; 280/651

(57) ABSTRACT

A folding pallet cart comprises four corner adapters that lock on to respective corners of an ordinary wooden pallet. A foldable frame has four vertical posts that fit at the bottom into each of the four corner adapters. The posts has holes in them to support a system of wire-frame shelves at various parallel levels above the/pallet. The pieces can be disassembled and folded up for storage.

### BACKGROUND OF THE INVENTION

1. Field of the Invention

The present invention relates to carts, and more particularly to frames and shelving that attach to standard pallets and can be folded down later for storage.

2. Description of Related Art

Pallets of live plants are routinely delivered by truck to retail stores like The Home Depot, Orchard Supply Hardware, Wal-Mart, etc. A typical Chep pallet is 40″ by 48″ and fits quite loosely across the floor inside a typical eight-foot wide truck-trailer.

More plants and other materials can be stacked on shelves above each pallet to take advantage of the vertical height inside a truck trailer or warehouse. But using wooden pallets for each of the higher stages consumes a lot of vertical room.

Floor rollers, conveyers, and wheeled dollies have been conventionally used to move materials around warehouses and in and out of truck-trailers. It is more convenient when the wheels are a part of the carts themselves.

A typical live plant distribution system returns to the dispatch office with empty carts. Unless those carts can collapse to save room, a lot of space is wasted that might otherwise be employed.

### SUMMARY OF THE INVENTION

Briefly, a folding pallet cart embodiment of the present invention comprises four corner adapters that lock on to respective corners of an ordinary wooden pallet. A folding frame has vertical posts that fit at the bottom into each of the four corner adapters. Holes in the posts support a system of wire-frame shelves at various parallel levels above the pallet. The pieces can be disassembled and folded to lie flat.

An advantage of the present invention is that a cart is provided that makes useful equipment from otherwise unused pallets.

Another advantage of the present invention is that a corner-adapter is provided that allows shelving to be assembled over a pallet.

A further advantage of the present invention is that caster-wheel assemblies are provided that can be used to convert a pallet into a roll-around cart or tray.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a perspective view of a cart embodiment of the present invention;

FIGS. 2A and 2B are perspective views of a typical corner adapter that can be fitted to the wooden pallet of FIG. 1;

FIG. 3 is an exploded assembly diagram of a cart embodiment of the present invention like that of FIG. 1;

FIG. 4 is a perspective diagram of a flared-side cart embodiment of the present invention;

FIG. 5 is a perspective view of a single frame like the one shown in FIG. 1 after being folded; and

FIG. 6 is a perspective view of four frames like the ones shown in FIGS. 1 and 5 after being folded and stacked.

### DETAILED DESCRIPTION OF THE INVENTION

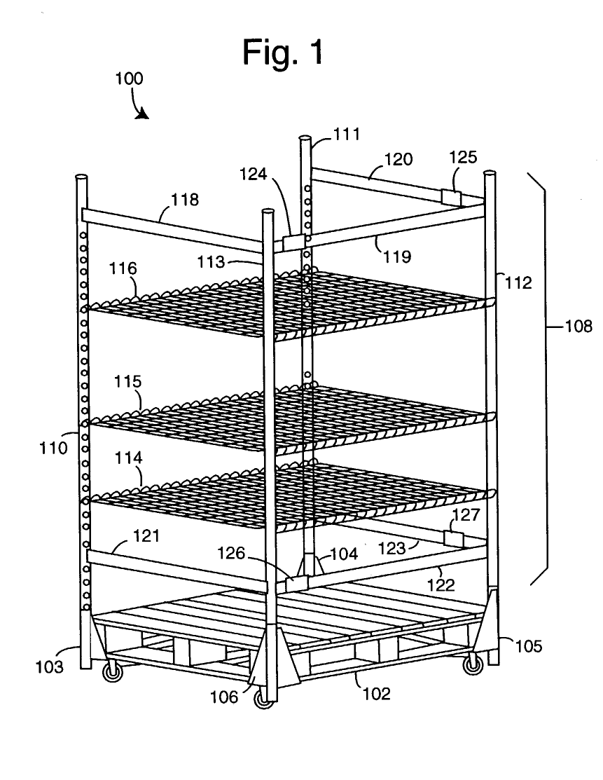

FIG. 1 illustrates a cart embodiment of the present invention, referred to herein by the reference numeral 100. In this example, a roll-around cart suitable for use in a warehouse or retail display is shown assembled. The cart 100 comprises a wooden pallet 102 to which are attached a set of four corner adapters 103-106. A frame 108 has four columns 110-113 that each plug into the tops of the corner adapters 103-106. A number of wire-frame shelves 114-116 hook onto holes provided on each of the four columns 110-113.

The four columns 110-113 are braced by a set of trusses 118-123. Trusses 119, 120, 122, and 123 are foldable, and include hinge/locks 124-127. Such allows the frame 108 to be unplugged from the corner braces and to folded up each side on the middle for compact storage. A simple construction that can be used to implement the hinge/locks 124-127 includes slipping a deep section of rectangular u-channel over a hinge connector that joins truss pieces. When in place, the u-channel prevents any pivoting of the hinges.

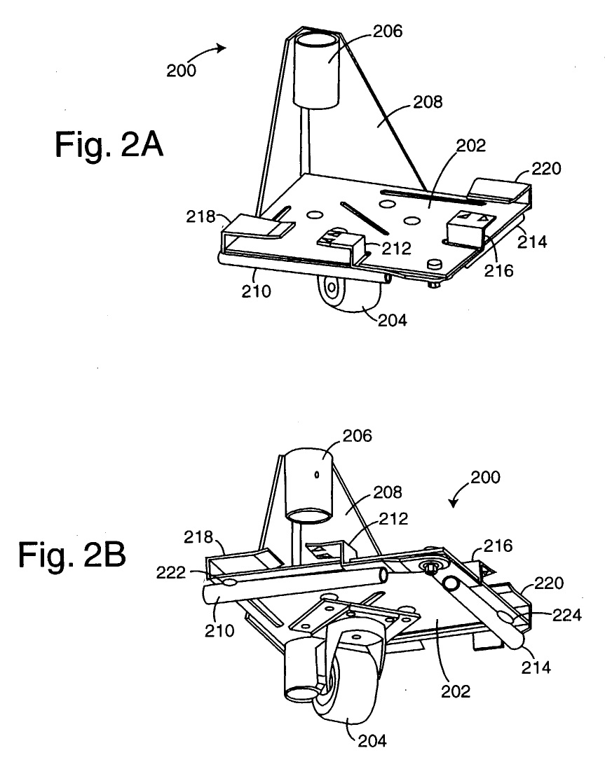

FIGS. 2A and 2B show a corner adapter 200 that comprises a base plate 202, a caster wheel 204, and a top post pocket 206 supported by a webbing 208. A lever 210 operates a pallet clip 212, and a second lever 214 operates a second pallet clip 216. A pair of outside edge clips 218 and 220 are intended to slip over pieces of lumber in the wooden pallet and the top of the base plate 202 supports a bottom corner of the pallet. The corner adapter 200 is locked on to the wooden pallet by rotating handles 210 and 214 so that clips 212 and 216 will capture a part of the pallet structure.

A single dimple 222 in base plate 202 is stamped in so that handle 210 will snap in behind it. Similarly, another dimple 224 is also stamped into the base plate 202 to hold in handle 214. These are preferred over notches that could be cut into the bottom edges of clips 218 and 220.

If the top post pocket 206 and webbing 208 are kept relatively short, several corner adapters 200 can be conveniently stacked one upon the other, e.g., for storage after disassembly of the cart 100.

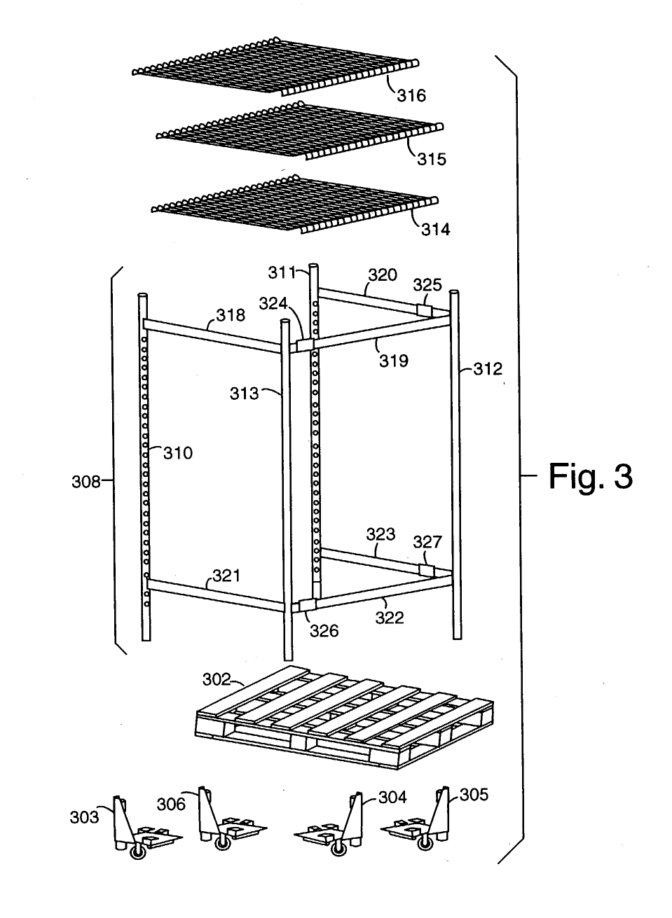

FIG. 3 shows a disassembled cart embodiment of the present invention, referred to herein by the reference numeral 300. The pieces of cart 300 comprise a wooden pallet 302 to which can be attached a set of four corner adapters 303-306. A frame 308 has four columns 310-313 that each plug into the tops of the corner adapters 303-306. A number of wire-frame shelves 314-316 hook onto holes provided on each of the four columns 310-313.

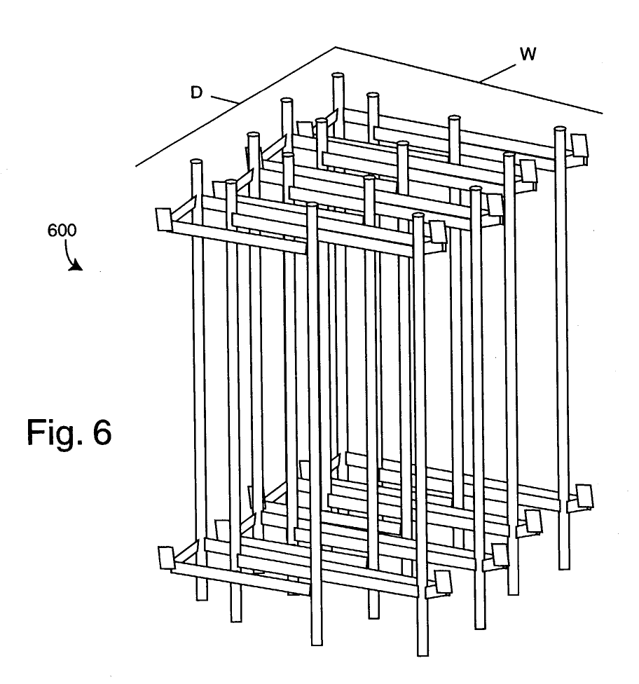

The four columns 310-313 are braced by a set of trusses 318-323. Trusses 319, 320, 322, and 323 are foldable, and include hinge/locks 324-327. Such allows the frame 308 to be unplugged from the corner braces and to folded up each side on the middle for compact storage, e.g., as in FIGS. 5 and 6.

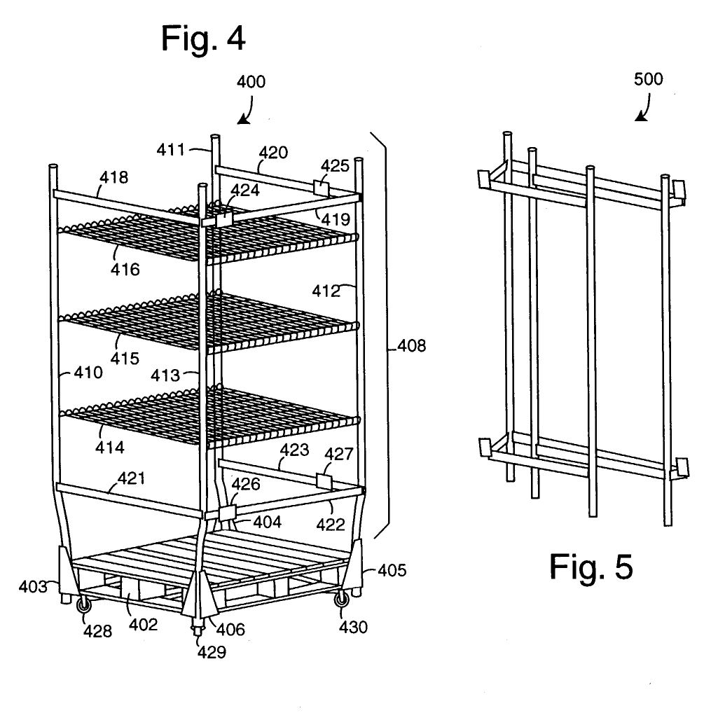

FIG. 4 illustrates an alternative flare-sided cart embodiment of the present invention, referred to herein by the reference numeral 400. Such flare-sided roll-around cart preferred for use in truck-trailers and is shown here assembled. The cart 400 comprises a wooden pallet 402 to which are attached a set of four corner adapters 403-406. Such pallet 402 is typically a Chep or block type that is 40″ by 48″. A foldable frame 408 is shaped to cantilever out beyond the area underneath of the pallet 402. This gives the whole cart, e.g., an outside dimension of about 44″ by 48″, and such fits better in numbers into a standard truck-trailer cargo area. The frame 408 comprises a set of columns 410-413 which are all preferably made of metal. For example, tubular steel or aluminum. Such metal tubing is easily bent into the S-shapes shown in FIG. 4.

A number of wire-frame shelves 414-416 attach inside the frame, e.g., by hooking into holes provided in the columns 410-413. A set of trusses 418-423 brace the columns. Some of the trusses are provided with hinges and locks 424-427. If the cart 400 needs to be able to be rolled around on the floor, wheels and/or casters can be added, e.g., caster wheels 428-430.

FIG. 5 is a perspective view of a single frame 500 like the ones shown in FIG. 1 after being folded.

FIG. 6 is a perspective view of four frames 600 like the ones shown in FIGS. 1 and 5 after being folded and stacked.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A cart, comprising:
a set of four corner adapters for fastening onto respective corners of a wooden pallet, and each having a post pocket on an upper side;
a shelving frame for plugging into a respective one of said post pockets; and
a plurality of shelves each able to be hung at a plurality of parallel levels inside the set of four columns.

2. The cart of claim 1, wherein:
the shelving frame further comprises a set of four columns each able to plug into a respective one of said post pockets.

3. The cart of claim 2, wherein:
the shelving frame further comprises a plurality of trusses that interconnect and support each one of said set of four columns.

4. The cart of claim 3, wherein:
the shelving frame further comprises a hinge disposed in each of said plurality of trusses that allows the shelving frame to be folded for storage.

5. The cart of claim 1, wherein:
the plurality of shelves comprises wire-frame shelves that hook on to holes provided in the shelving frame.

6. The cart of claim 1, further comprising:
a wheel attached to a bottom side of each of the set of four corner adapters.
